(19) United States
(12) Patent Application Publication
(10) Pub. No.: US 2008/0280275 A1
(43) Pub. Date: Nov. 13, 2008

(54) Hand washing timer

(76) Inventor: Charles T. Collopy, Fort Collins, CO (US)

Correspondence Address: CR MILES, P.C.;CRAIG R. MILES, 405 MASON COURT, SUITE 119, FORT COLLINS, CO, 80524, US

(21) Appl. No.: 11/803,159

(22) Filed: May 11, 2007

(51) Int. Cl. G09B 19/00; G01F 11/00; B67D 5/06; B67D 5/00; B67D 1/07; B67D 5/08

(52) U.S. Cl. 434/236; 222/638; 222/1; 222/39; 222/23; 222/321.9; 222/192

(57) ABSTRACT

Generally, a material dispenser having reciprocal means which operates to deliver an amount of material from a material delivery conduit and generates timed indicia of elapse of a dispensed material use interval. Specifically, a hand wash dispenser having reciprocal means which operates to deliver an amount of hand wash material and generates timed indicia of elapse of a hand wash interval.

### I. BACKGROUND

Generally, a material dispenser having a reciprocal means which operates to deliver an amount of material from a container and generates timed indicia of elapse of a dispensed material use interval. Specifically, a hand wash material dispenser having reciprocal means which operates to deliver an amount of hand wash material from a container and generates timed indicia of elapse of a hand wash interval.

Conventional hand washing procedures utilizing soap and water may be the single most effective practice that prevents the spread of germs in the general population. Experts also unequivocally agree that conventional hand washing with soap and water can reduce the incidence of nosocomial infections; however, compliance with hand washing guidelines is embarrassingly and unacceptably low. In fact, studies have consistently demonstrated that the rate of hand washing compliance is less than 50 percent. This failure to comply with hand washing guidelines may contribute to nosocomial infections which have been shown to complicate between six percent and 14 percent of admissions in pediatric institutions. These hospital infections are the fourth leading cause of death.

Even though numerous conventional technologies have been developed to promote the proper application and use of hand wash materials to meet procedural guidelines or regulations with respect to hand washing specifically, and to promote the proper application and use of dispensed materials such as cosmetics or household products in general, a number of problems remain unresolved with respect to the proper application and use of hand washing agents specifically and dispensed materials in general.

A significant problem with conventional hand washing technology can be that while the user understands the importance of proper application and use of a hand wash material, they tend to overestimate their own compliance with procedures or guidelines. With respect to hand washing, healthcare workers understand the importance of hand washing, but they tend to overestimate compliance with hand washing guidelines. Therefore, even when various conventional technologies are made available they may not be used because users may incorrectly believe they are already using the hand wash properly, or in compliance with hand washing guidelines.

Another significant problem with conventional hand washing technologies can be user distaste for external intervention. For example, healthcare workers are not in favor of interventions involving rewards and punishments to achieve hand washing compliance. As such, technologies which provide portable, individualized, hand washing agent dispensers which track and store into memory the site where workers dispense hand wash agents as described by U.S. Pat. No. 6,392,546; or the use of modules at wash sinks into which employees input identification codes to track compliance, may actually reduce compliance or may be disfavored by employees.

Another significant problem with conventional hand washing technology may be that ineffective or less effective conventional technologies are selected when they are easier to use. Healthcare workers are attracted to interventions that make hand washing easier. As such, heathcare workers may develop a reliance on pre-moistened towelettes, waterless hand cleaners, or wipes. However, pre-moistened towelettes do not effectively clean and do not take the place of hand washing. Waterless hand cleaners or pre-moistened towelettes should not be used as a substitute for washing hands with soap and water.

Another significant problem with conventional hand washing technology may be that different hand wash materials may have different performance characteristics. For example, various types of antiseptic ingredients included in hand wash materials, may have different performance characteristics. Antiseptic agents may differ as to duration of time to achieve maximum reduction in bacteria counts. Alcohol based preparations, for example, require less time to effect maximum reduction in bacterial counts than did, for example, a product containing chlorhexidine gluconate (CHG). Indeed, a one-minute immersion or scrub with alcohol is as effective as a four to seven minute skin preparation with other antiseptics. Hexachlorophene on the other hand may not be particularly fast acting and its rate of killing is slow to intermediate. As such, proper use of different hand wash materials requires

Perhaps common to each of these prominent problems with conventional hand washing technology and generally with the use of conventional dispensed material technologies may be the lack of any sensorial perceivable indicia generated by the hand wash material dispenser or cosmetic material dispenser to inform the user that an amount of time for efficacious use of the hand wash material or other material has elapsed. As such, provision of feed back to the user of conventional hand wash materials and dispensed materials has involved timing by use of separate timers or signaling devices, or activity recording or retrieval devices. Alternately, in those devices in which timers are installed, the devices may not portable or the timer is not made a part of the dispensing means operated by the user to dispense the hand wash material as described by U.S. Pat. No. 5,771,925.

The instant inventive material dispenser addresses each of these problems related specifically to dispensing hand wash materials and the proper use of hand washing materials and in general to dispensing materials and the proper use of dispensed materials.

### II. SUMMARY OF THE INVENTION

Accordingly, a broad object of the invention can be to provide a timed indicia generator joined to a reciprocal means which travels from a first position toward a second position to dispense an amount of material such timed indicia element capable of emitting at least one sensorial perceivable indicia upon elapse of a material use interval which commences coincident with start of travel of the reciprocal means.

Another broad object of the invention can be to provide a material flow generator responsive to a reciprocal means which travels from a first position toward a second position to dispense an amount of material with such reciprocal means joined to at least one timed indicia element capable of emitting at least one sensorial perceivable indicia upon elapse of a material use interval which commences coincident with start of travel of the reciprocal means.

Another broad object of the invention can be to provide a portable material dispenser which provides a timed indicia generator capable of emitting at least one sensorial perceivable indicia upon elapse of a material use interval which commences coincident with start of travel of a reciprocal means from a first position toward a second position which operates a material flow generator which dispenses an amount of material from a container.

Another broad object of the invention can be to provide as one embodiment of a reciprocal means a dispenser body which in one piece provides a timer and a material delivery conduit having a material delivery passage fluidicly joined to a hollow piston slideably engaged to a hollow sleeve of a pump assembly such dispenser body as one piece travels from a first position toward a second position to dispense an amount of material from a container and to provide at least one sensorial perceivable indicia of elapse of a material use interval.

Naturally, further objects of the invention are disclosed throughout other areas of the specification, drawings, and claims.

### III. A BRIEF DESCRIPTION OF THE DRAWINGS

FIG. 1 is a perspective view which shows a particular method of using a particular embodiment of the inventive material dispenser.

FIG. 2 is an exploded view of a particular embodiment of the dispenser body.

FIG. 3 is a top view of a particular embodiment of the dispenser body.

FIG. 4 is a front view of a particular embodiment of the dispenser body.

FIG. 5 is a side view of a particular embodiment of the dispenser body.

FIG. 6 is a cross section view of a particular embodiment of the dispenser body.

FIG. 7 is a particular embodiment of a timer circuit which operates to time a material use interval and activate a timed indicia generator.

### IV. DETAILED DESCRIPTION OF THE PREFERRED EMBODIMENTS

Generally, a material dispenser having reciprocal means which operates to deliver an amount of material from a material delivery conduit and generates sensorial perceivable indicia of elapse of a dispensed material use interval. Specifically, a hand wash dispenser having reciprocal means which operates to deliver an amount of hand wash material and generates timed indicia of elapse of a hand wash interval.

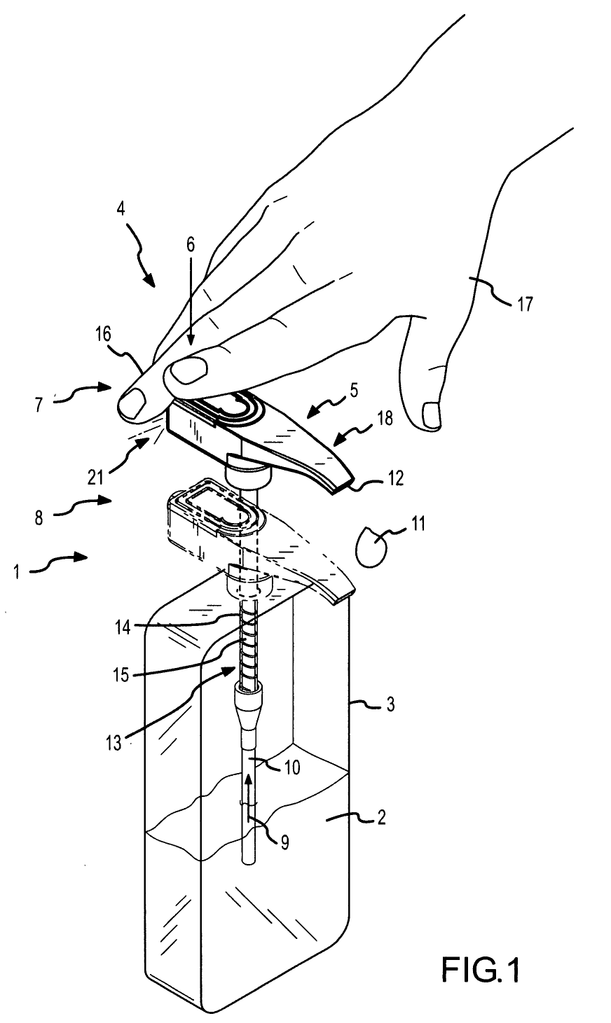

Now referring to FIG. 1, a method of using an embodiment of the inventive material dispenser (1) is illustrated. A material (2) can be located in a container (3). The material (2) can be any manner of material (2) which can be delivered from the container (3) as further discussed below and without limitation can be a material (2) such as: a substance, a composition, a mixture, a liquid, a solution, a lotion, a cream, a detergent, a hand wash, a body wash, a shampoo, a conditioner, a liquid soap, a medicament, a food product, a drink product, a cleaning product, an additive, or the like. As such, while examples of the inventive material dispenser (I) are provided in the context of delivering a hand wash material for hand washing, it is not intended that the inventive material dispenser (1) be limited to dispensing hand wash materials. Rather the specific examples provided herein are intended to provide sufficient description such that the person of ordinary skill in the art can make and use the inventive material dispenser (1) in wide variety of applications including but not limited to the best mode of the invention described herein.

Similarly, while a particular configuration of the container (3) is shown in FIG. 1, the container (3) can be configured in any manner capable of containing an amount of the material (2). The container can be generated from any of a numerous and wide variety of container materials compatible with the material (2) to be located therein, such as: a plastic material, a ceramic material, a clay material, a metal material, or the like, whether individually or in various permutations and combinations.

In dispensing the material (2) from the container (3), a part of a body (4) of a person (not shown) can engage a reciprocal means (5) of the material dispenser (1) to forcibly urge the reciprocal means (5) to travel (6) from a first position (7) toward a second position (8) to generate a flow of the material (9) from within the container (3) through a material delivery passage (10) to dispense an amount of the material (11) from a material delivery aperture (12). The person can utilize the amount of material (11) dispensed from the material delivery aperture (12) for the intended application of the material (2). As but one example, the amount of material (11) dispensed can be a hand wash material which can be utilized in a hand washing application.

The term “reciprocal means” broadly encompasses the part of the material dispenser (1) which travels from the first position (7) toward the second position (8) and back toward the first position (7) in substantially the same travel path to operate a material flow generator (13) capable of generating the flow of material (9) through the material delivery passage (10) which communicates with the material (2) in the container (3) and the material delivery aperture (12). As shown in FIG. 1, the reciprocal means (5) can in part provide a hollow sleeve (14) in which a hollow piston (15) travels as part of a liquid pump assembly such as described by U.S. Pat. No. 6,056,163 or U.S. Pat. No. 6,832,916, each hereby incorporated by reference herein. However, the reciprocal means (5) is not limited by these specific examples and the reciprocal means (5) can as a further non-limiting example can be a pivot arm which reversibly rotates through an arcuate travel path about a pivot to operate the material flow generator (13). The material flow generator (13) made responsive to the reciprocal travel of the pivot arm can generate the flow of material (9) through the material delivery passage (10).

FIG. 1 also shows the fingers (16) of a hand (17) of a person engaging the reciprocal means (5) to generate travel (6) of the reciprocal means (5) from a first position (7) toward a second position (8) to dispense an amount of the material (11), however, the invention is not so limited and any part of the body (4) of a person can be engaged with the reciprocal means (5) to forcibly urge the reciprocal means (5) to travel (6) from a first position (7) toward a second position (8), such as a part of the palm of the hand, a part of the forearm, the thumb, the back of the hand, a part of the foot, or the like. Understandably, the part of the body (4) may be further covered with a material layer such as the material layer associated with a glove on the hand, a shirt over the forearm, a shoe on the foot, or the like and the term part of a body (4) of a person should be understood to further include such material layer(s) or other extension elements engaged by the part of the body (4) of a person which can be directed by a person to engage the reciprocal means (5) to generate travel (6).

FIG. 1 further shows one example of an external surface configuration (18) of the reciprocal means (5) capable of being engaged by the fingers (16) of the hand (17) of the person to generate travel (6) from the first position (7) toward the second position (8) to dispense an amount of material (11), however, the invention is not so limited and the external surface configuration (18) of the reciprocal means (5) can manifest in any manner useful to facilitate engagement with a part of the body (4) of a person as above-defined without limitation.

By engaging the reciprocal means (5) with the part of the body (4) of the person, a timer (19)(further described below) located in the reciprocal means (5) of the material dispenser (1) can be activated to provide sensorial perceivable indicia (21) timed to indicate a dispensed material use interval. For example, if the intended application for the amount of material (11) dispensed by the material dispenser (1) is hand washing then generation of the sensorial perceivable indicia (21) indicates that hand washing with the amount of material dispensed can be discontinued. That indication can be provided by discontinuing emission of the sensorial perceivable indicia (21) upon elapse of the dispensed material use interval or alternately by commencing emission of the sensorial perceivable indicia (21) upon elapse of the dispensed material use interval.

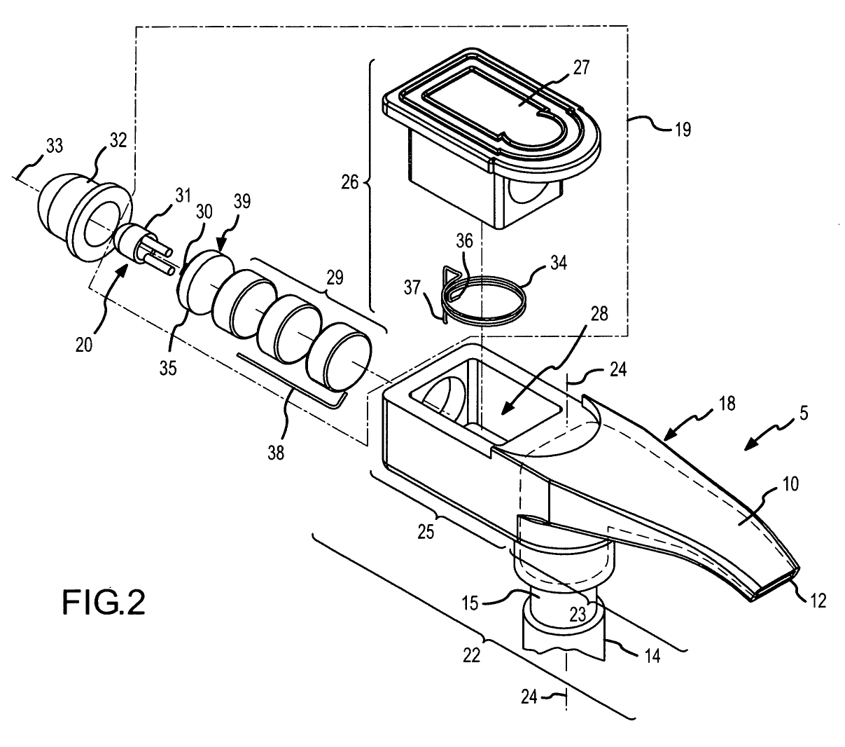

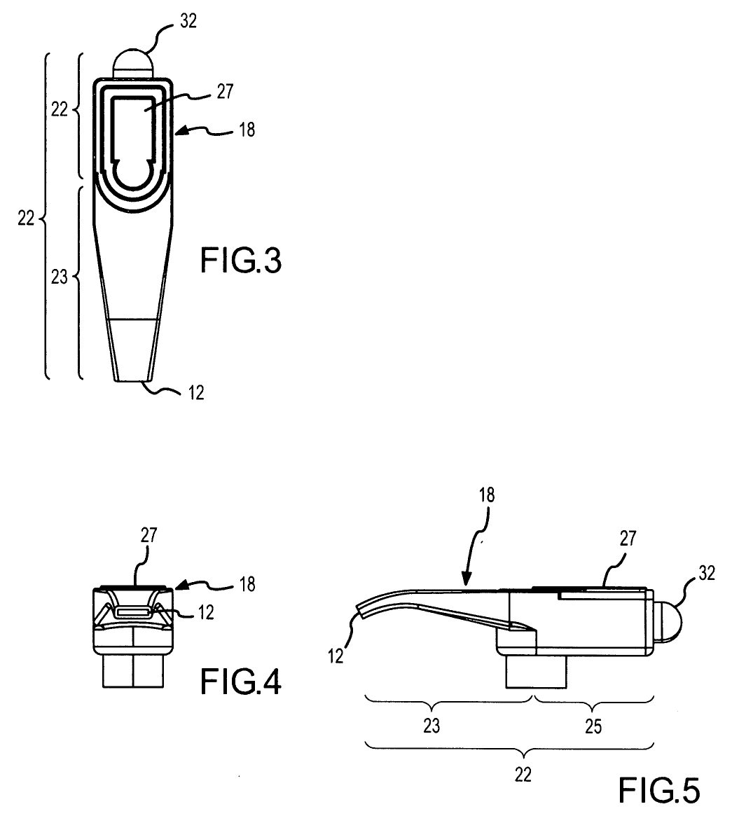

Now referring primarily to FIGS. 2-6, the reciprocal means (5) can further provide in part an inventive dispenser body (22). The dispenser body (22) provides a material delivery conduit (23) which defines in part the material delivery passage (10)(in dashed lines) which receives the flow of material (9) generated by the material flow generator (13) and fixes the location of the material delivery aperture (12) from which an amount of material (11) can be dispensed. As shown primarily in FIGS. 2-6, a particular embodiment of the dispenser body (22) can include a material delivery conduit (23) which extends outwardly from the longitudinal axis (24) of the hollow sleeve (14) in which the hollow piston (15) travels. While this particular embodiment of the dispenser projection element (23) can be utilized to facilitate delivery of an amount of hand wash material to the hand (17), the invention is not so limited, and a numerous and wide variety of material delivery conduit (23) configurations are possible each configuration positioning the material delivery aperture (12) at location consistent with the intended application of the amount of material (9) dispensed.

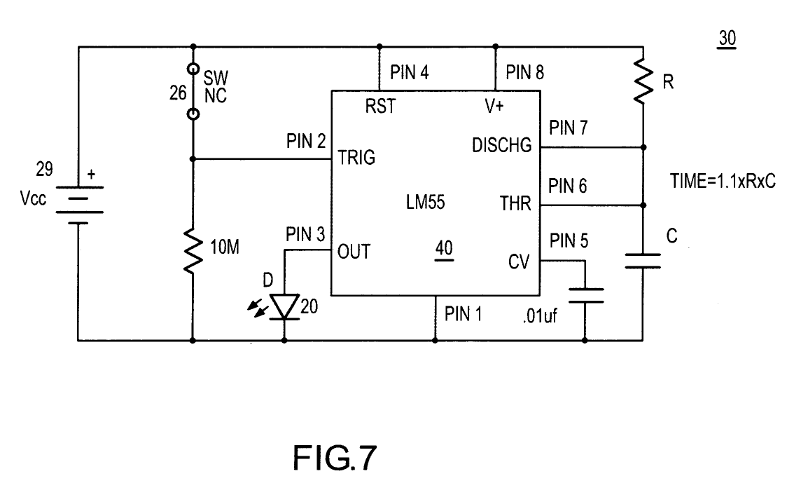

Again referring primarily to FIGS. 2-6, the dispenser body (22) can further provide a timer housing (25) which receives the elements of the timer (19). The timer (19) can provide a timer circuit (30) configured as shown in FIG. 7, as but one non-limiting example. The timer housing (25) and timer (19) coupled to the material delivery conduit (23) provides an external surface configuration (18) of the dispenser body (22) which upon forcible urging of a part of the body (4) of the person travels as one piece. The configuration of the timer housing (25) and the timer (19) provides an external switch surface (27) positioned to allow switched operation of the timer (19) upon engagement the dispenser body (22) with the part of the body (4) of a person. As shown in FIGS. 2-6, the external switch surface (27) can form a part of the external surface configuration (18) of dispenser body (22) engaged by the part of the body (4) of the person. As to certain embodiments of the timer (19), the external switch surface (27) can comprise a flexible membrane having sufficient flexure upon engagement with the part of the body (4) of the person to allow compression and decompression of the coils of a spring (34) which establishes the open condition and closed condition of the switch of a timer circuit (30)(see FIG. 7), as further described below.

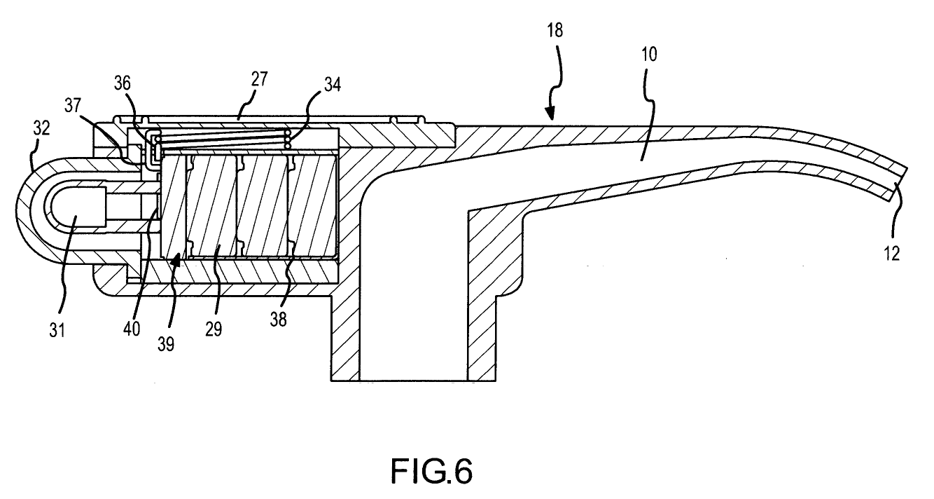

The timer housing (25) further provides a hollow space (28) to receive a power source (29) of the timer (19). As shown primarily in FIGS. 2 and 6, certain embodiments of the timer housing (25) provide a hollow space (28) configured to receive a power source (29) in a small form-factor button cell battery. Particular embodiments of the button cell battery suitable for use as part of the timer (19) provides a single cell with nominal voltages between about 1.5 volts (“V”) and about 3 V having a cylindrical external surface which establishes the positive (+) terminal. Button cell batteries suitable for use with the invention typically have a diameter of between about 4.8 millimeters (“mm”) to about 15 mm and a height of between about 1.2 mm to about 3.2 mm. For example, a button cell package size SR516 can be utilized with particular configurations of the timer housing (25) and can be obtained from a variety of sources such as Rayovac, Atlanta, Ga.

Embodiments of the timer housing (25) can provide hollow space (28) in which the power source (29) configured as a plurality of button cell batteries can be stacked anode to cathode to increase the useful life span of the power source (29). While the embodiment of the timer housing (25) shown in the Figures provides a hollow space in which three button cell batteries are stacked anode to cathode, this particular hollow space (28) configuration is not intended to limit the useful configurations of the hollow space (28) in which, depending upon the application, a greater or lesser number of batteries can be located.

Now referring primarily to FIGS. 2-6, the timer housing (25) can further provide a hollow space configured to receive a timer means (39). The term “timer means” (39) as used herein provides all the necessary conductors and all the necessary components which along with the switch (26) and the power source (29) provide for timing of a material use interval and activation of the timed indicia generator (20) to indicate elapse of the material use interval. Depending on the application, the duration of the material use interval timed may vary. For example, if the material (2) dispensed from the container (3) comprises a hand wash material such as a liquid hand soap, the material use interval may be set at between about 15 seconds and about 25 seconds which is the minimum amount of hand washing time presently understood to be efficacious with regard to removing pathogens from the skin. If as a second example, the material (2) dispensed from the container (3) is a hair conditioner, the material use interval may be set between about 30 seconds and 60 seconds. Understandably, the material use interval could be adjusted to any desired period of time corresponding to the duration of time the material (2) delivered from the container (3) should be used for a particular application (the timer being preset by the manufacturer or as to certain embodiments of the invention adjustable by the user).

The timed indicia generator (20) activated to indicate elapse of the material use interval generates sensorial perceivable indicia (21) to indicate that use of the material (2), or the amount of material (11) dispensed, or the method of using the amount of material (11) dispensed from the container (3) can be discontinued. The circuit diagram shown in FIG. 8 indicates one particular embodiment of the timed indicia generator (20) as a light emitting diode (“LED”) (31) which depending on the LED utilized can emit a visible white, red, green, or yellow light as the sensorial perceivable indicia (21) utilizing a drive current of between about 10 mA to about 50 mA with a voltage drop of between about 1.2Volts (V) to about 5.0V. LEDs suitable for use with the invention can be obtained from various sources such as Philips Lumileds Lighting Company, San Jose, Calif. and other suppliers. An LED cover (32) can be utilized to capture and diffuse the emitted light over a increased surface area.

However, this particular example of a timed indicia generator (20) and sensorial perceivable indicia (21) is not intended to limit the invention to an LED which emits an amount of light. Rather, the term “timed indicia generator” (20) can without limitation include as but a few examples: light emitting diodes, piezoelectric sound generators, mechanical buzzers, magnetic buzzers, piezoelectric sirens, piezoelectric indicators, tone generators, speakers, digital messages, vibrotactile bars, pulsating transducers, or the like, and the term “sensorial perceivable indicia” (21) is intended to broadly encompass any manner of indication or emission perceivable by the person such as: a light, a sound, an odor, a motion, a message, or the like.

Now referring primarily to FIGS. 2, 6, and 7, the timer means (39) of the timer (19) can include a substrate layer (35) such as conventional FR-4 substrate layer patterned with conductors by one of a variety of processes (such as silk screen printing, photoengraving, or milling) which electrically couple certain components of the timer means (39) such as resistors, capacitors, and a timer element (40) (such as a LM55 timing element available from National Semiconducter, 2900 Semiconductor Drive, Santa Clara, Calif.) of the timer circuit (30). As shown primarily by FIGS. 2, 6 and 7 the timer means (39) can have a substrate layer (35) of cylindrical configuration of similar diameter to the button cell batteries. This particular configuration of the timer means (39) can stack adjacent to the energy source (29) of button cell batteries with a coincident longitudinal axis (33) in the hollow space (28) of the timer housing (25).

Now referring primarily to FIG. 7, a diagram of a timer circuit (30) indicating all conductors and components suitable for use with the invention is shown. As to this particular non-limiting embodiment of a timer circuit (30), the timer switch (26) is normally closed. With respect to the embodiment of the timer (19) shown in FIGS. 2 and 6, the timer switch (26) utilizes the the spring (34) to provide a first contact element (36) which electrically connects to the trigger of the timer element (40) (for example, pin 2 of the LM55 timer element as shown in the timer circuit (30) (see FIG. 7)). The spring (34) further provide a second contact element (37) which electrically engages and disengages the power source (29). The second contact element (37) upon compression and decompression of the coils of the spring (34) travels from a first location to a second location on the surface of the timer means (39) which engages and disengages the second contact element (37) with a conductor coupled to the power source (29) to switch the timer circuit (30) from the normally closed condition to the open condition to trigger operation of the timer element (40) to time the material use interval and activate the timed indicia generator (20). Understandably, as to other embodiments of the timer switch (26) and timer circuit (30), the switch could be in the normally open condition and operate to establish the closed condition to trigger operation of the timer circuit (30). The spring (34) while shown as a coil spring could have numerous and varied configurations which operate in similar or different fashion to provide the open condition or closed condition of the timer circuit (30). As to the embodiments of the power source (29) which include a plurality of cells, a ground element (38) can be located to electrically couple the cells in the timer circuit (30).

As can be easily understood from the foregoing, the basic concepts of the present invention may be embodied in a variety of ways. The invention involves numerous and varied embodiments of a hand wash timer and methods of making and using such hand wash timer. As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “timer” should be understood to encompass disclosure of the act of “timing”—whether explicitly discussed or not—and, conversely, were there effectively disclosure of the act of “timing”, such a disclosure should be understood to encompass disclosure of a “timer” and even a “means for timing.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the material dispenser devices herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. A material dispenser, comprising:
a) a container;
b) a material in said container;
c) a material dispenser which provides a reciprocal means which travels from a first position toward a second position to dispense an amount of said material from said container; and
d) a timer located in a part of said reciprocal means of said material dispenser, wherein said timer includes:
i) a timer means;
ii) a timed indicia element which upon activation of said timer circuit operates to indicate elapse of a dispensed material use interval;
iii) a switch having a location on said reciprocal means of said material dispenser to engage of a part of a hand to activate said timer; and
iv) a power source which delivers an amount of energy to said timer sufficient to operate said timed indicia element to indicate elapse of said material use interval.

2. A material dispenser as described in claim 1, wherein said reciprocal means comprises a plunger.

3. A material dispenser as described in claim 1, wherein said reciprocal means comprises a lever.

4. A material dispenser as described in claim 2, wherein said timed indicia element comprises an illumination element.

5. A material dispenser as described in claim 2, wherein said timed indiciq element comprises vibration element.

6. A material dispenser as described in claim 2, wherein said timed indicia element comprises a sound generation element.

7. A material dispenser as described in claim 4, wherein said switch comprises a spring responsive to a flexible membrane which engages said part of said hand to activate said timer, wherein said spring provides a first contact element and a second contact element, wherein said first contact element electrically engages a trigger of a timer element, and wherein said second contact element travels to electrically engage said power source.

8. A material dispenser as described in claim 7, wherein said material in said container comprises a hand wash material and wherein said a dispensed material use interval comprises a dispensed material use interval of between about 5 seconds and about 30 seconds.

9. A material dispenser as described in claim 7, wherein said material in said container comprises a cosmetic material and wherein said a dispensed material use interval comprises a dispensed material use interval of between about 5 seconds and about 1 hour.

10. A method of dispensing a material, comprising the steps of:
a) containing a material in a container;
b) engaging with a part of a hand a reciprocal means coupled to said container;
c) activating a timer coupled to said reciprocal means by engagement of said part of said hand with said reciprocal means;
d) generating travel in said reciprocal means from a first position towards a second position to dispense an amount of material from said container;
e) timing a dispensed material use interval; and
f) indicating elapse of said dispensed material use interval by generation of a sensorial perceivable indicia.

11. A method of dispensing a material as described in claim 10, further comprising the step of generating an amount of flexure in a flexible material coupled to a part of said reciprocal means to close a switch to activate said timer.

12. A method of dispensing a material as described in claim 11, wherein said step of containing a material in a container comprises containing a hand wash material in said container.

13. A method of dispensing a material as described in claim 12, wherein said step of timing a dispensed material use interval comprises the step of timing a hand wash interval having a duration of between about 5 seconds to about 20 seconds.

14. A method of dispensing a material as described in claim 11, wherein said step of containing a material in a container comprises containing a cosmetic material in said container.

15. A method of dispensing a material as described in claim 14, wherein said step of timing a dispensed material use interval comprises the step of timing a cosmetic use interval having a duration of between about 5 seconds to about 1 hour.

16. A method of dispensing a material as described in claim 13, wherein said sensorial perceivable indicia comprises a sensorial perceivable amount of sound.

17. A method of dispensing a material as described in claim 13, wherein said sensorial perceivable indicia comprises a sensorial perceivable amount of vibration.

18. A method of dispensing a material as described in claim 13, wherein said sensorial perceivable indicia comprises a sensorial perceivable amount of light.
